(19) United States
(12) Patent Application Publication
(10) Pub. No.: US 2008/0285319 A1
(43) Pub. Date: Nov. 20, 2008

(54) Method and apparatus achieving a high power factor with a flyback transformer

(76) Inventor: Cecil W. Deisch, Warrenville, IL (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/804,599

(22) Filed: May 18, 2007

(51) Int. Cl. H02M 3/335

(52) U.S. Cl. 363/90

(57) ABSTRACT

Common household power transformers (e.g., “wall warts”) typically exhibit poor power factors, which, in turn, cause energy losses to power grids and adversely affect current waveforms in the power grids. AC-to-DC power conversion with good power factor is achieved using a transformer, power switch coupled in series with the primary side of the transformer, and switching controller. The switching controller measures current through the primary side of the transformer, via a current sense element, and controls the power switch to enable and disable current through the primary side of the transformer. The switching controller generates a power switch control signal at a frequency with a duty factor that changes non-linearly as a function of an instantaneous current through the primary side of the transformer. As a result, a power factor of greater than 90% or even 95% can be achieved.

### BACKGROUND OF THE INVENTION

A common design objective of power-conversion circuits is to achieve an acceptable power factor (PF). In an alternating current (AC) power system, power factor is defined as a ratio of the real power to the apparent power, and is a number between 0 and 1. A power factor of less than 1 indicates the apparent power is higher than the real power, and may be caused by distortion in the current drawn from a power source by a load. A low power factor may further cause losses in a power distribution system, thereby increasing requisite power delivered to the system. For this reason, it is beneficial to utility companies that power consumers employ power supplies with a relatively high power factor.

### SUMMARY OF THE INVENTION

Embodiments of the invention provide alternating current (AC) to direct current (DC) conversion using a transformer and power switch in a flyback arrangement to achieve a relatively high power factor (PF). Embodiments include a full-wave rectifier to receive an AC input and provide a rectified power signal. In one embodiment, a transformer receives the rectifier output. The transformer may be controlled by a power switch connected in series with the primary side of the transformer in a flyback arrangement. The power switch is operable to enable and disable current flow through the primary side of the transformer. A current sense element is also coupled in series with the primary side of the transformer. The power switch is controlled by a power switch control signal, enabling and disabling current according to this signal. A switching controller measures current through the transformer, via the current sense element, and generates the power switch control signal. The switching controller generates the power switch control signal at a frequency with a duty factor that changes non-linearly as a function of an instantaneous current through the primary side of the transformer. As a result, the switching controller defines, in part, current flow through the transformer, providing an AC-to-DC conversion with relatively high power factor.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A is a power distribution system diagram that illustrates a typical power distribution system and “wall wart” transformer.

FIG. 1B is a circuit schematic diagram of a prior art “wall wart” transformer.

FIG. 1C is a signal diagram of line current and voltage at the circuit of FIG. 1B.

FIG. 2A is a block diagram illustrating an AC-to-DC power converter with a flyback controller.

FIG. 2B is a circuit schematic diagram of an AC-to-DC power converter with a flyback controller encompassing an embodiment of the present invention.

FIG. 2C is a graph illustrating operation of the flyback controller of FIG. 2B.

FIG. 3A is a circuit schematic diagram of an AC-to-DC power converter with a flyback controller encompassing an embodiment of the present invention.

FIG. 3B is a graph illustrating operation of the flyback controller of FIG. 3A.

### DETAILED DESCRIPTION OF THE INVENTION

A description of example embodiments of the invention follows.

Many low-power consumer devices are powered by direct current (DC) power from commercial alternating current (AC) mains. A simple “wall wart” transformer is a common device for converting the AC to DC for these consumer devices. The wall wart plugs into an AC socket and typically employs a step-down transformer, a full-wave bridge rectifier and a filter capacitor to provide a DC output. Due to its simplicity, a wall wart is typically durable, low-cost, and provides high-voltage isolation to connected devices.

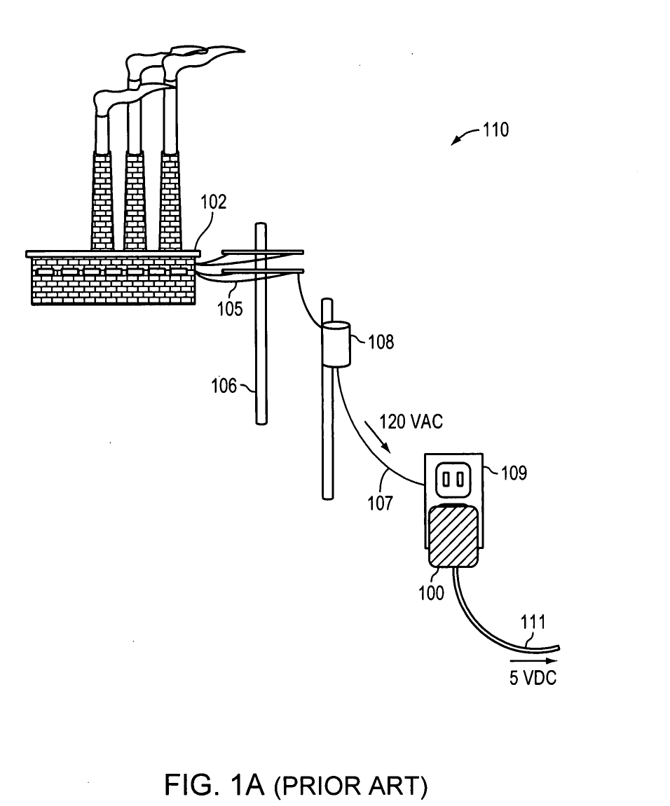

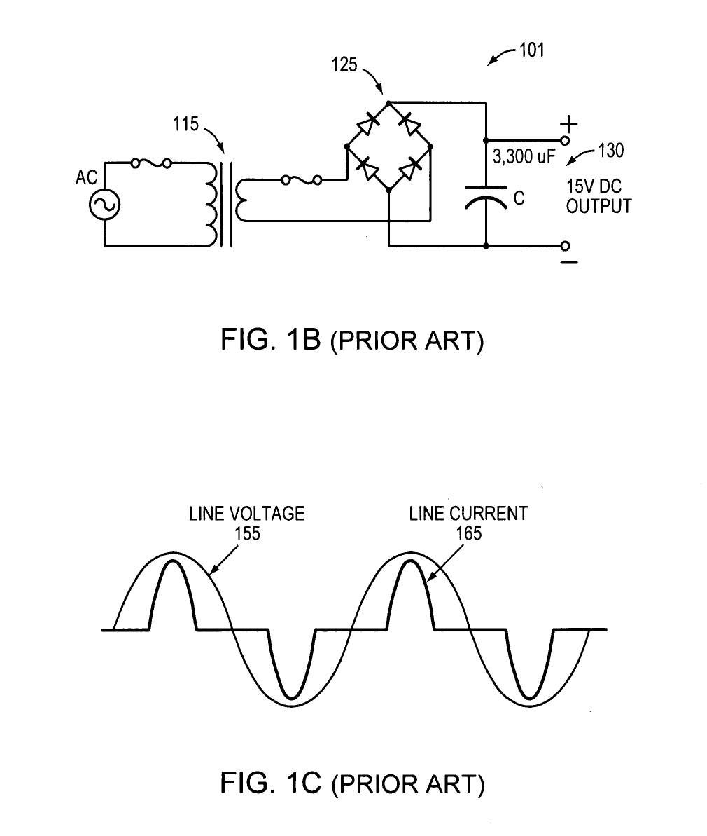

FIG. 1A illustrates a typical power distribution system 110 providing power to a wall wart transformer 100. A power plant 102 generates electrical current that is distributed across high-voltage lines 105 supported by a distribution tower 106. From the tower 106, a high-voltage line 105 terminates at a pole-mounted step-down transformer 108, which transforms the high-voltage AC transmission current to a lower-voltage AC transmission for use by a customer. A customer line 107 connects the lower-voltage AC supply to a customer power circuit (not shown), which, in turn, provides power (e.g., 120 VAC) to a common wall outlet 109. A wall wart 100 is plugged into the outlet 109 and includes a transformer (not shown) to transform the received AC power to a low-voltage DC output (e.g., 5 VDC or 12 VDC). The wall wart 100 may be connected, via the output line 111, to one or more compatible electronic devices, such as a laptop computer, telephone, music player, or other devices.

FIG. 1B illustrates a circuit 101 of a typical prior-art wall wart transformer, such as the wall-wart 100 of FIG. 1A. A step-down transformer 115 receives an AC input to its primary side, having a greater number of windings than its corresponding secondary side, and provides a lower voltage AC output to the full-wave rectifier 125. The full-wave rectifier 125 includes a diode bridge to rectify the respective AC input, providing a full-wave rectified signal. This rectified signal is filtered by a capacitor C to provide an approximate DC signal at the DC output 130.

As described above, the circuit 101 of a prior-art wall wart transformer produces an isolated, low voltage, DC output from an AC mains. However, the circuit 101 has a number of drawbacks, including poor efficiency and low power factor. Power factor is defined in an AC power system as a ratio of real power to apparent power, presented as a number between 0 and 1. Apparent power is the product of the current and voltage to the system and is equal to or greater than the real power of the system. A low power factor indicates that the apparent power is much greater than the real power, the ratio of real power to apparent power being low, e.g., 0.6. Such a low power factor indicates a relatively greater flow of current to the circuit than the current component of the real power, which may result in energy losses at transmission lines delivering the AC input to the power system.

FIG. 1C is a signal diagram approximating line voltage 155 and line current 165 at the AC input of the wall-wart circuitry 101 of FIG. 1B. The signal diagram illustrates the wall-wart circuitry 101 exhibiting a low power factor, which is a result of the circuitry 101 drawing current at narrow “spikes” (shown by the line current 165) at each positive and negative peak in the line voltage 155.

Embodiments of the present invention, described below, provide an AC-to-DC converter exhibiting a relatively high power factor. In some embodiments, AC-to-DC conversion is achieved via a flyback transformer, which typically includes a transformer with a power switch configured to enable and disable current through the primary side of the transformer. By controlling current through the transformer via the power switch, power conversion with good power factor (e.g., 95% or higher) can be achieved.

An example AC-to-DC converter of the present invention includes a full-wave rectifier to provide a full-wave rectified signal from an AC power input. A transformer is coupled to the full-wave rectifier at its primary side to receive the rectified signal. The converter further includes a current sense element to measure current through the primary side and a power switch that is coupled in series with the primary side of the transformer to enable and disable current through the primary side of the transformer. Further, a switching controller generates a power switch control signal to control the power switch at a frequency with a duty factor that changes non-linearly as a function of the instantaneous voltage at the output of the full-wave rectifier.

In further embodiments, the switching controller may include a circuit having one or more subcircuits to (i) produce a first signal derived as a function of an output voltage of the transformer and a current through the primary side of the transformer; (ii) produce a second signal having a non-linear, time-varying function defined in part by operation of the transformer; and (iii) compare the first signal with the second signal and output a third signal to change a state of the power switch control signal based on a result of comparing the first and second signals. Such circuits may include a combination of active and passive components and digital logic. The circuits may determine the second signal based on an error voltage. A charging capacitor may also be configured to define a portion of the second signal. The circuits may further include a switch configured to discharge the capacitor at a fixed frequency selected in part based on operational characteristics of the transformer.

The switching controller may measure the current through the primary side of the transformer at a substantially consistent point during each cycle of a clock frequency. The switching controller may further measure this current to measure each time the power switch returns to an open state.

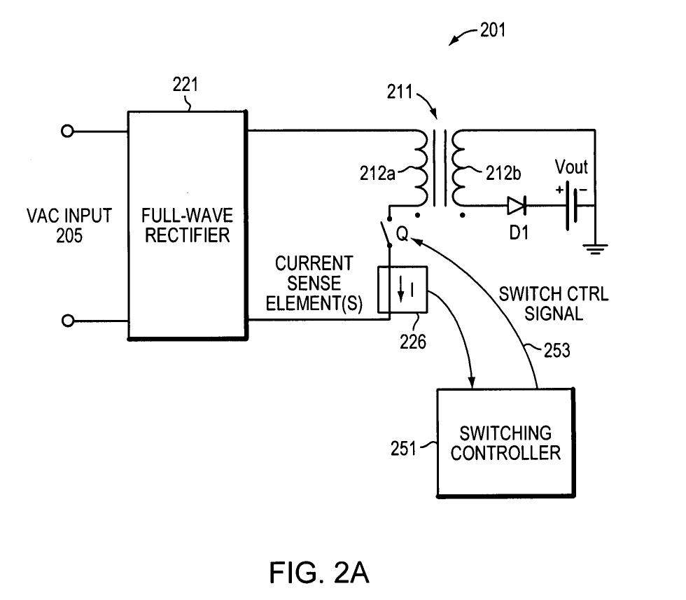

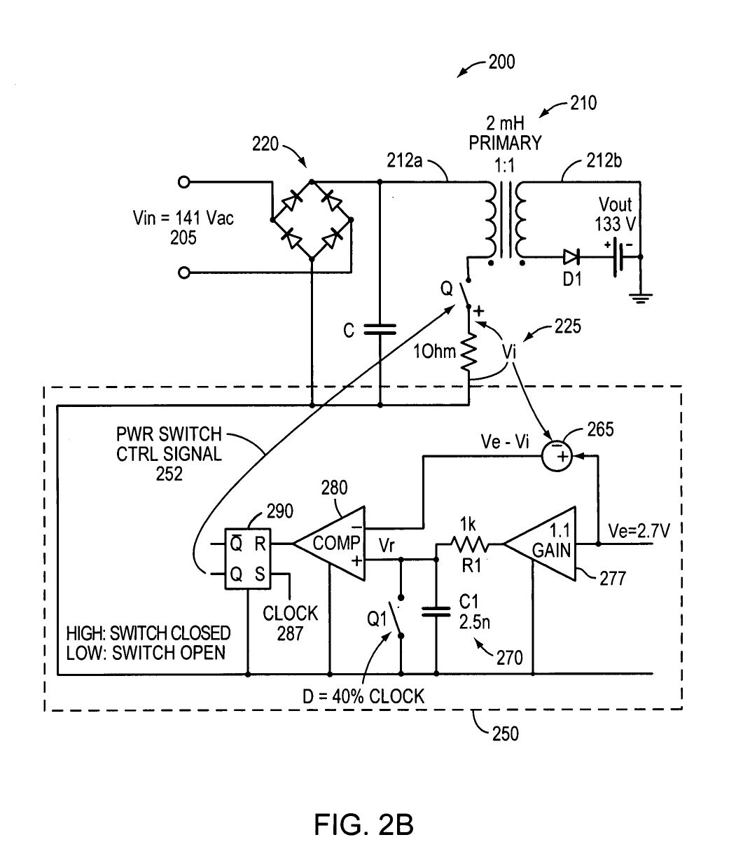

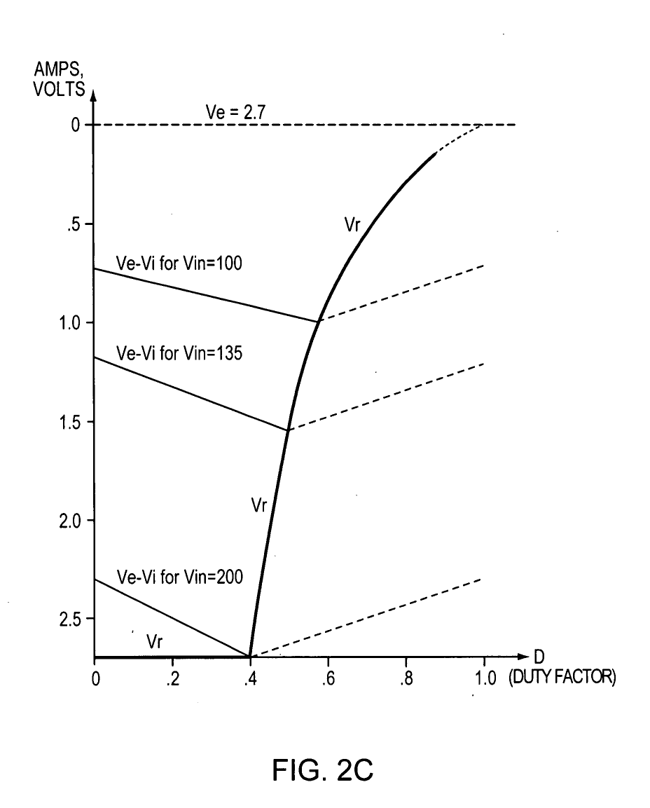

FIG. 2A is a high-level block diagram of an AC-to-DC power converter 201 encompassing an embodiment of the present invention. A full-wave rectifier 221 receives an AC input (e.g., 120 VAC or 240 VAC) and outputs a full-wave rectified signal. A transformer 211 is coupled to the output of the full-wave rectifier 221 so that the primary side (“primary winding”) 212a of the transformer 211 receives the full-wave rectified signal. A power switch Q is also coupled in series with the primary side of the transformer 211 in a flyback arrangement. Through this flyback arrangement, the switch Q is operable to enable and disable current flow through the primary side of the transformer 211. Also coupled in series with the primary side of the transformer 211 is a current sense element 226, which measures current through the primary winding 212a of the transformer 211 and the power switch Q. Any form of current sense elements, including electrical or electromagnetic current sense elements, may be used to sense current through the primary winding 212a. The secondary winding 212b is coupled to a diode D1 and, if this secondary winding has fewer turns than the primary, provides a lower-voltage DC output Vout.

The power switch Q may be controlled by a switching controller 251 to switch at a frequency higher than the AC mains input, enabling the transformer 211 to operate as a flyback transformer. When the power switch Q is closed, current from the full-wave rectifier 221 extracts energy from the output of 221 and stores it in the magnetic field generated by the primary side of the transformer 211. When the power switch Q is then opened, the break in primary current causes the voltage across the transformer windings 212a and 212b to reverse and the stored energy is deposited in the output through D1.

The switching controller 251 is coupled to the current sense element 226 and power switch Q. The switching controller 251 measures current through the primary side of the transformer 211 via the current sense element 226. In addition, the switching controller 251 controls the power switch Q, causing it to enable and disable the current I through the primary side of the transformer 211. The switching controller 251 exhibits this control by generating a power switch control signal 253, which is a pulse-width modulated (PWM) signal that controls the state of the power switch Q. For example, in one embodiment, the power switch control signal 253 at “high” state causes the power switch Q to close, while the power switch control signal 253 at “low” state causes the power switch Q to open. In another embodiment, reverse logic states may be used to control the states of the switch Q.

The power switch control signal 253 is further controlled by the switching controller 251 to be generated at a frequency with a variable duty factor. For example, the control signal 253 may become “high” in response to a clock signal input (not shown). The switching controller 251 may further switch the control signal output 253 to a “low” state according to an instantaneous current measured by the current sense element 226. Further, a non-linear circuit (not shown) at the switching controller 251 controls the aforementioned switching. The non-linear circuit determines the switching based on the measured instantaneous current through the transformer 211, as well as one or more non-linear circuit elements (not shown). As a result, the duty factor of the control signal 253, being the measure of time per switching cycle that the switch is closed, changes non-linearly as a function of an instantaneous current through the primary side of the transformer 221. Moreover, as a result of the duty factor being controlled in a defined, non-linear manner, the AC-to-DC converter 201 exhibits a high power factor. Particular AC-to-DC converters embodying the present invention may achieve a power factor greater than 0.9, with some embodiments achieving a power factor of 0.95 or greater.

FIG. 2B is a detailed circuit schematic diagram of an AC-to-DC power converter 200 with a flyback switching controller 250 encompassing an embodiment of the present invention. A full-wave rectifier 220 receives an AC input (e.g., 120 VAC or 240 VAC) and outputs a full-wave rectified signal. A capacitor C is coupled to the rectifier 220 output to carry the high-frequency currents taken by the switching converter, but is essentially an open circuit at the low AC mains frequency (typically 50 or 60 Hz). The primary winding 212a of a transformer 210 is also coupled to the output of the full-wave rectifier 220 to receive the full-wave rectified signal. A power switch Q is coupled in series with the primary winding 212a of the transformer 210 in a flyback arrangement. Through this flyback arrangement, the switch Q is operable to enable and disable current flow through the primary winding 212a. Also coupled in series with the primary winding of the transformer 210 is a current sense element 225, which measures current through the primary winding 212a and the power switch Q. In the example embodiment, the current sense element 225 is a low value resistor, such as a 1 ohm resistor.

The secondary winding 212b of the transformer 210 is coupled to a diode D1 to provide a DC output Vout. The secondary winding 212b may include any number of windings relative to the primary winding 212a to achieve a selected voltage output at Vout. In this example, a 1:1 turns ratio between the primary 212a and secondary 212b windings enables a 133V VDC output for an input of 141 VAC. For applications requiring a lower-voltage DC output (e.g., low-power devices commonly powered by a wall-wart), the secondary winding 212b may have fewer turns relative to the primary winding 212a to achieve a specified output voltage at Vout.

A switching controller 250 controls the power switch Q to switch at a high frequency (e.g., 100 kHz), enabling the transformer 210 to operate as a flyback transformer. The switching controller 250 generates a power switch control signal 252, which defines the switching behavior of the power switch Q. The switching controller 250 includes a comparator 265 that outputs the difference between the received instantaneous current measured by the current sense element 225 and a received error voltage Ve, described in the paragraph immediately below. The switching controller 250 further includes non-linear circuitry 270, a comparator 280 and a latch 290, such as an R-S latch. The non-linear circuit 270 (i.e., a subcircuit of the switching controller 250) includes a 1.1 gain amplifier 277, which receives the error voltage Ve, a resistor R1, a capacitor C1 and a switch Q1 coupled in parallel with the capacitor C1.

The error voltage Ve may be generated, for example, by an error circuit (not shown) that compares the output Vout to a reference voltage, the error voltage Ve being a function of this difference. The error circuit may further limit the error voltage Ve to a maximum voltage (2.7 volts in this example) in order to limit the maximum power output at Vout, thereby preventing a power overload.

A signal opening and closing a second switch Q1 is derived from a clock (not shown) 287 providing a high-frequency clock input (“Clock”), having a fixed duty factor of the Clock 287. In this example embodiment, the duty factor is 40% of the Clock 287. The latch 290 outputs the power switch control signal 252, which controls the state of the power switch Q. The control signal 252 is set and reset, respectively, by the Clock 287 and output of the comparator 280. As a result, the Clock 287 effectively controls the power switch Q to close, while the comparator 280 effectively controls the power switch Q to open.

By resetting the latch 290, the comparator 280 determines the duty factor of the power switch control signal 252, being a result of comparing the differential inputs Vr (output of the non-linear circuit 270) and (Ve−Vi) (output of the comparator 265). The comparator 280 resets the latch 290 when the voltage Vr becomes greater than the voltage (Ve−Vi). However, the voltage Vr changes non-linearly over each cycle of the Clock as determined by the non-linear circuit 270. The resulting comparison of Vr and (Ve−Vi) therefore changes non-linearly over the Clock 287 cycle as a function of the instantaneous current through the primary side of the transformer 210. This function is described in further detail below with regard to FIG. 2C.

By controlling the power switch control signal 252 as described above, the switching controller 250 continuously controls the duty factor of the power switch over each cycle of the AC mains input voltage such that the average switch current (and hence the average input current) during each switching cycle is proportional to the instantaneous rectified voltage. Keeping the proper average input current during each switching cycle is accomplished by varying the duty factor of the power switch by comparing the instantaneous switch current with a non-linear time function of the error voltage Ve. By maintaining an average input current proportional to the input voltage throughout each cycle of the AC mains, the AC-to-DC converter 200 exhibits a high power factor.

FIG. 2C is a graph illustrating operation of the flyback switching controller 250 of FIG. 2B. The line Vr represents the non-linear function generated by the voltage across C1. The downward-sloping lines represent the trajectories of switch current for several points on the rectified AC mains voltage. During each half cycle of the rectified AC mains, the voltage rises from zero up to a peak then drops back to zero. FIG. 2C shows the switch current trajectories of three sample voltages: 200, 135, and 100 volts.

For example, if the error voltage, Ve, is 2.7 volts and the peak of the rectified input voltage happens to be at 200 volts, the lower downward-sloping line (Ve−Vi for Vin=200) is the trajectory. At the beginning of the cycle (D=0), the switch is closed, switch current starts at about 2.3 A and begins ramping until the trajectory intersects with Vr when D=0.4. At this point, switch current is 2.7 A so Ve−Vi=0 and the voltage across C1 is also zero so the latch 290 turns off main switch Q. The rising dashed line from this intersection point represents how the current in the flyback transformer decays from D=0.4 to D=1.0. Note that the endpoint of this dashed line is also about 2.3 A; the same as the starting point.

As the voltage of the rectified input waveform drops to, say 100 volts (and the error voltage remains essentially constant at Ve=2.7 volts throughout a half-cycle of the AC mains), the switch current begins the switching cycle at about 0.7 A and ramps downward until it intersects the non-linear Vr line at about D=0.55. At this duty factor point, Vr is about 1.7 volts, switch current is about 1 A so the inputs of comparator 380 are equal voltage, the latch 390 is tripped and the main switch Q is turned off. Again, the dashed line shows the current decays to about 0.7 A a the end of the switching cycle.

With reference to FIG. 2B, at the start of the Clock 287 cycle (D=0), the switch Q1 of the non-linear circuit 270 is closed, resulting in Vr being 0V. For this example, after 40% of the clock cycle (D=0.4), the switch Q1 opens, causing the voltage Vr to rise as the capacitor C1 is charged. The voltage Vr therefore rises in a non-linear exponential curve which closely approximates the ideal Vr curve if the R1C1 time function is appropriately chosen. Observe, that if the error voltage Ve is limited to 2.7 volts for this example switching converter, input current to this converter is automatically limited to 2.7 A. Additionally, if the peak of the input voltage rises above 200 volts, the average input current during this peak is still limited to 2.7 A or less; thus providing automatic overload protection.

Note that as the DC load on the secondary of transformer 210 decreases to, say, half, the error voltage V3 also decreases to about half so the non-linear charging voltage across C1 has the same shape, but has half the amplitude. This causes the average input current per switching cycle to be about half that of the full-load current described above. Thus, good power factor is maintained over a wide range of DC secondary loads.

The non-linear switching current threshold curve Vr depends upon continuous current flow in flyback transformer 210; that is, the switch current at turn-on is always greater than zero.

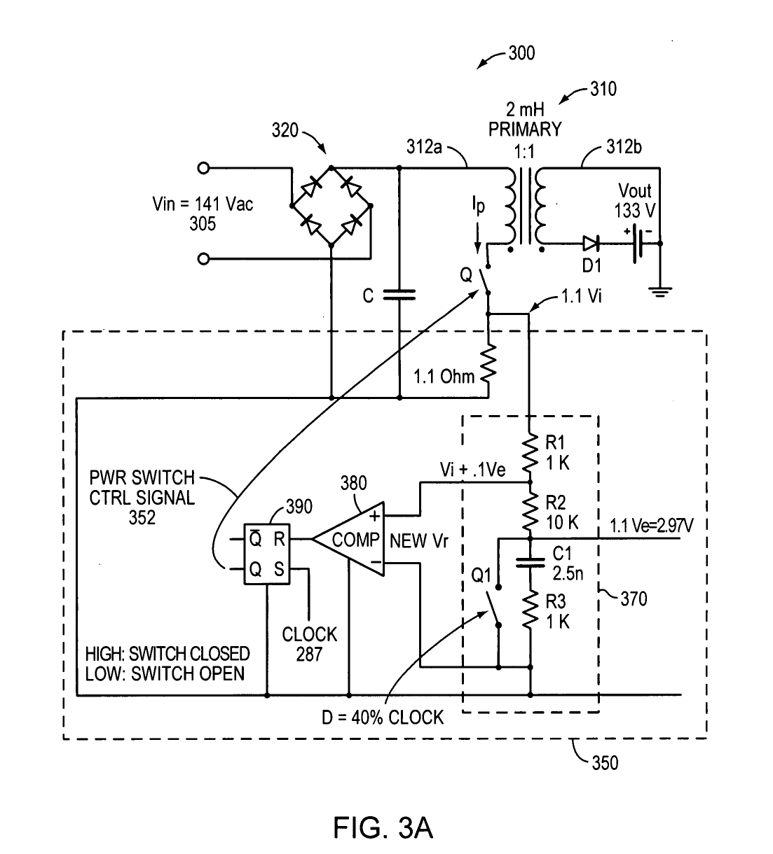

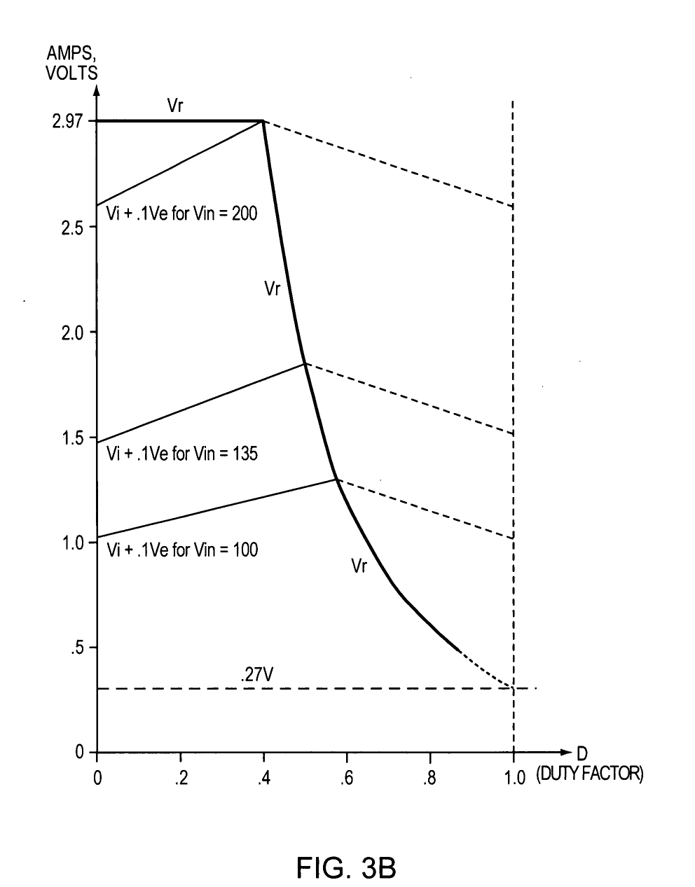

FIG. 3A is a circuit schematic diagram of an AC-to-DC power converter 300 with a flyback controller encompassing a second embodiment of the present invention. The converter 300 is comparable to the converter 200 of FIG. 2B, but uses fewer circuit elements, eliminates an op-amp and generates a power switch control signal 352 in a different manner. Specifically, rather than using active analog circuitry, the embodiment of FIG. 3A employs passive analog circuitry to produce Vr.

The converter 300 includes a full wave rectifier 320, the output of which is coupled to a capacitor C, primary winding 312a of a transformer 310, and power switch Q. These circuit elements operate comparably to the respective elements of the converter 200 of FIG. 2B, thereby providing a DC output Vout from the secondary winding 312b of the transformer 310.

A switching controller 350 includes a latch 390, comparator 380, and non-linear circuit 370. The switching controller 350 is comparable to the controller 250 of FIG. 2B in that the latch 390 generates the power switch control signal 352, being set and reset by a Clock and the output of comparator 380. In contrast to the controller 250 of FIG. 2B, the non-linear circuit 370 of FIG. 3A includes a series of resistors R1, R2 and R3, a capacitor C1, and a switch Q1. Circuit 370 receives a voltage, 1.1Vi, corresponding to the current Ip through the primary winding 312a of the transformer 310, and an error voltage, 1.1Ve=2.97, for example. For comparison with the embodiment of FIG. 2B, the values Vi and Ve are equivalent across FIGS. 2B and 3A. The switch Q1 is controlled by the Clock 387, having a 40% duty factor.

The non-linear circuit 370 generates two signals, Vr and (Vi+0.1Ve), which are compared at the comparator 380. From this comparison, the latch 390 resets the power switch control signal 352 to “low,” thereby opening the power switch Q and thus determining the duty factor of the power switch Q. This operation is described in further detail below with reference to FIG. 3B.

FIG. 3B is a graph illustrating operation of the switching controller 350 of FIG. 3A. The voltages Vr and (Vi+0.1Ve) are shown over one period of the Clock 387 cycle. The voltage (Vi+0.1Ve) depends on the instantaneous voltage Vin at the input 305, and, so, is shown for Vin values at 100, 135 and 200 volts, which are example values for which power factors greater than 90% by the AC-to-DC flyback converter 300 have been calculated to design the switching controller 350, which resulted in identifying the non-linear circuitry 370 in the example embodiment of FIG. 3A.

With reference to FIG. 3A, the voltages Vr and (Vi+0.1Ve) are generated by the non-linear circuit 370 and are received by the comparator 380 for comparison. At the start of the Clock 387 cycle (D=0), the switch Q1 of the non-linear circuit 270 is closed, resulting in Vr being 2.97V. After 40% of the clock cycle (D=0.4), the switch Q1 opens, causing the voltage Vr to decrease as the capacitor C1 is charged. The voltage Vr therefore decreases as a function of the non-linear circuit 370, resembling a curve across the remainder of the cycle. The voltage (Vi+0.1Ve) increases over an initial portion of the clock cycle, resulting from the increasing current through the primary winding 312a of the transformer 310 as indicated by the voltage Vi. Depending on the input voltage Vin, the voltage (Vi+0.1Ve) becomes greater than Vr, as shown by the respective intersection points between Vr and (Vi+0.1Ve). At substantially (e.g., ±1%, ±5%, ±10%) the moment of intersection, which may include some hysteretic factor, the comparator 380 causes the control signal 352 to enter a low state, causing the power switch Q to open.

Given the example operation of the switching controller 350 described above, the power switch Q has a duty factor corresponding to substantially the point of intersection between Vr and (Vi+0.1Ve). For example, for Vin=200V, Vr and Vi+0.1Ve intersect at approximately 40% of the clock cycle, resulting in a duty factor of 0.4 for the power switch Q. For Vin=135V, Vr and (Vi+0.1Ve) intersect at approximately 47% of the clock cycle, resulting in a duty factor of 0.47. Further, for Vin=100V, Vr and (Vi+0.1Ve) intersect at approximately 57% of the clock cycle, resulting in a duty factor of 0.57. For input voltages at other values, a corresponding duty factor is determined by the switching controller 350 in a similar manner.

Embodiments of the present invention, such as the AC-to-DC converters 200, 300 of FIGS. 2B and 3A, respectively, may be configured to operate over different voltage ranges than those described above. For example, the example AC-to-DC converters 200, 300 can be configured to support 100-to-240 Vac to cover international ranges. With reference to FIGS. 2B and 3A, the converters 200, 300 are configured to deliver a maximum of 100 watts at the DC output Vout. For a nominal input of 115 VAC, a limiting circuit (not shown) may prevent the error voltage Ve from exceeding 2.7 V as shown, thereby preventing an overload at a load (not shown) coupled to the DC output Vout. Likewise, for a 240 VAC input, limiting Ve to a maximum of 1.35 V maintains the maximum power at 100 watts. Moreover, the maximum power output for a given input voltage can be adjusted by selecting a different maximum value of Ve. Thus, the maximum error voltage Ve can be configured to accommodate a range of input voltages (e.g., 100 to 240 VAC) while maintaining a fixed maximum power output, and may also be configured to provide a higher or lower maximum power output. It should be understood that circuits well known in the analog or digital arts may be used to support automatic or manual adjustment of the maximum error voltage Ve to allow operation on whatever international power grid the AC-to-DC converter 200, 300 is connected.

In further embodiments of the present invention, an AC-to-DC converter may employ non-analog forms of circuits, such as digital circuits, including digital logic, firmware, processor executing software, or combination thereof, to control the power switch, operating as a switching controller as described above. In such an embodiment, with reference to FIG. 2A, the switching controller 251 may be a digital PWM controller. Here, the digital controller 251 may compare the output voltage Vout to a reference voltage, generating an error voltage Ve in the digital domain. In a digital embodiment, at the beginning of the switching cycle, the digital controller 251 turns the power switch Q ON. At several instances during the switching cycle, the digital controller 251 may sample the voltage across the current sense element 226, by converting the voltage to digital form, and scale the voltage relative to the error voltage Ve. At each sampling instant, the scale digital sample is compared to a pre-programmed value corresponding to that sampling instant in a lookup table, for example. If the sample is less than the lookup number, the power switch Q is left ON; if the digital sample is equal to or greater than the lookup number, then the digital controller 251 turns the power switch Q OFF. After a pre-set time has elapsed, indicating the end of the switching cycle, the digital controller 251 turns the power switch Q ON and repeats the above process for subsequent switching cycles.

While this invention has been particularly shown and described with references to example embodiments thereof, it will be understood by those skilled in the art that various changes in form and details may be made therein without departing from the scope of the invention encompassed by the appended claims.

What is claimed is:

1. An AC-to-DC converter, comprising:
a full-wave rectifier;
a transformer, with a primary side and a secondary side, coupled to an output of the full-wave rectifier;
a power switch coupled in series with the primary side of the transformer in a flyback arrangement and operable to enable and disable current flow through the primary side of the transformer;
a current sense element coupled to the primary side of the transformer to sense current flow through the primary side of the transformer; and
a switching controller coupled to the current sense element and power switch and configured to measure current through the primary side of the transformer via the current sense element and generate a power switch control signal to control the power switch at a frequency with a duty factor that changes non-linearly as a function of an instantaneous current through the primary side of the transformer.

2. The converter of claim 1 wherein the switching controller includes a circuit comprising:
a first subcircuit to produce a first signal derived as a function of an output voltage of the transformer and a current through the primary side of the transformer;
a second subcircuit to produce a second signal having a non-linear, time-varying function defined in part by operation of the transformer; and
a comparator to compare the first signal with the second signal and output a third signal to change a state of the power switch control signal based on a result of comparing the first and second signals.

3. The converter of claim 2 wherein the second subcircuit includes active components to determine the second signal based on an error voltage.

4. The converter of claim 3 wherein the second subcircuit includes a capacitor configured to charge to define a portion of the second signal.

5. The converter of claim 3 wherein the second subcircuit includes digital logic to determine the second signal based on an error voltage.

6. The converter of claim 2 wherein the second subcircuit includes passive components to determine the second signal based on an error voltage.

7. The converter of claim 6 wherein the second subcircuit includes a capacitor configured to charge to define a portion of the second signal.

8. The converter of claim 7 wherein the second subcircuit includes a switch configured to discharge the capacitor at a fixed frequency selected in part based on operational characteristics of the transformer.

9. The converter of claim 1 wherein the switching controller measures the current through the primary side of the transformer to measure each time the power switch returns to an open state.

10. The converter of claim 1 wherein the switching controller measures the current through the primary side of the transformer at a substantially consistent point during each cycle of a clock frequency.

11. The converter of claim 1 wherein the switching controller is configured to generate the power switch control signal with a duty factor to control the power switch and, in turn, control current flow through the primary side of the transformer to convert power from AC to DC at a power factor of between 0.9 and 0.99.

12. A method of providing AC-to-DC conversion, comprising:
rectifying an AC input signal to produce a rectified signal;
transferring the rectified signal through a primary side of a transformer;
measuring instantaneous current through the primary side of the transformer; and
switching current through the primary side of the transformer at a frequency with a duty factor that changes non-linearly as a function of the instantaneous current through the primary side of the transformer.

13. The method of claim 12 further comprising:
comparing (i) a first signal derived as a function of an output voltage of the transformer and a current through the primary side of the transformer with (ii) a second signal having a non-linear, time-varying function defined in part by operation of the transformer; and
changing a state of the power switch control signal based on a result of the comparing the first and second signals.

14. The method of claim 13 further comprising actively generating the second signal to determine the second signal based on an error voltage.

15. The method of claim 14 wherein generating the second signal includes generating the second signal by approximating an ideal non-linear curve in an analog manner.

16. The method of claim 14 wherein generating the second signal includes determining, using digital calculations, the second signal based on an error voltage.

17. The method of claim 13 further comprising passively generating the second signal based on an error voltage.

18. The method of claim 17 wherein generating the second signal includes charging a capacitor to define a portion of the second signal.

19. The method of claim 18 further comprising discharging the capacitor at a fixed frequency selected in part based on the operational characteristics of the flyback transformer.

20. The method of claim 12 wherein the measuring instantaneous current includes measuring current each time the power switch returns to a closed state.

21. The method of claim 12 wherein the measuring instantaneous current includes measuring current measured at each cycle of a clock frequency.

22. The method according to claim 12 wherein switching current through the primary side of the transformer with a frequency and duty factor that changes non-linearly causes the flyback transformer to convert power from AC to DC at a power factor of between 0.9 and 0.99.

23. A switching controller for controlling current through a flyback transformer in an AC-to-DC converter, comprising:
calculation circuitry to produce a first signal derived as a function of an output voltage of a flyback transformer and a current through a primary side of the flyback transformer;
non-linear circuitry configured to generate a second signal to have a non-linear, time-varying function defined in part by operation of the flyback transformer; and
a comparator configured to generate a power switch control signal having an active state set by a clock signal and reset by a result of comparing the first signal with the second signal to enable and disable current through the flyback transformer.
